(19) United States
(12) Patent Application Publication
(10) Pub. No.: US 2008/0146165 A1
(43) Pub. Date: Jun. 19, 2008

(54) DYNAMIC FREQUENCY SYNTHESIZER PROGRAMMING

(75) Inventors: JASON T. YOUNG, PALM CITY, FL (US); ROBERTO GAUTIER, DAVIE, FL (US); WALDEMAR W. SIEROCINSKI, DAVIE, FL (US); WILLIAM J. WINGFIELD, PLANTATION, FL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/611,596

(22) Filed: Dec. 15, 2006

(51) Int. Cl. H04B 1/40

(52) U.S. Cl. 455/76

(57) ABSTRACT

A system (100) and method (200) for dynamic frequency synthesizer programming is provided The method can include identifying (202) a first operating frequency (120) of a first oscillator (250), identifying a second operating frequency (121) of a second oscillator (255), and adjusting the first operating frequency if the first operating frequency and the second operating frequency are within a pre-determined range (155) for suppressing an interference between the first oscillator and the second oscillator. In one configuration, the first operating frequency can be changed (121) by a pre-specified offset if the first oscillator is in transmit mode (121) and the second oscillator is in receive mode (142). In another configuration, the first operating frequency can be changed by a pre-specified offset if the first oscillator is in transmit mode (121) and the second oscillator is in transmit mode (141).

### FIELD OF THE INVENTION

The present invention relates to wireless communication systems, and more particularly, to managing operation of multiple communication modules.

### INTRODUCTION

The use of portable electronic devices and mobile communication devices has increased dramatically in recent years. A mobile device generally has a communication unit that includes a transmitter and a receiver. The transmitter and the receiver can include a local oscillator that generates a carrier frequency for modulating or demodulating a communication signal. The local oscillator can be implemented as an analog or a digital frequency synthesizer. A frequency synthesizer can generate a carrier frequency or accurately lock onto a carrier frequency. A receiver may include a frequency synthesizer for demodulating a received communication signal to base-band. The transmitter may include a frequency synthesizer for modulating a base-band signal to a carrier frequency.

Recently, dual-mode mobile devices have been introduced that are capable of supporting multiple communication modules. A narrowband communication module may provide Frequency Division Multiple Access (FDMA), Time Division Multiple Access (TDMA), or integrated Dispatch Enhanced Network (iDEN) modulation schemes. A wideband communication module may provide Orthogonal Frequency Division Multiplexing (OFDM) or Code Division Multiple Access (CDMA). Orthogonal Frequency Division Multiplexing (OFDM) is a well-known, multi-carrier data transmission technique, used in wireless communications for achieving high throughput over a time-dispersive radio channel, without the need for a channel equalizer in the receiver. CDMA is also a well-known form of multiplexing that uses codes to spread a signal energy over a larger bandwidth to achieve high capacity and robustness to interference.

A Mobile device can implement multiple communication modules, each having separate transmit and receive modems. However, during dual-mode operation, a first communication module may generate interference in a second communication module. This can reduce a transmit and receive signal quality for both communication modules in the mobile device. A need therefore exists for managing an operation of multiple communication modules in a mobile device.

### SUMMARY

One embodiment of the invention is a method for dynamic frequency synthesizer programming. The method can include identifying a first operating frequency of a first oscillator, identifying a second operating frequency of a second oscillator, and adjusting the first operating frequency if the first operating frequency and the second operating frequency are within a pre-determined range. In one configuration, the first operating frequency can be changed by a pre-specified offset if the first oscillator is in transmit mode and the second oscillator is also in transmit mode. In another configuration, the first operating frequency can be changed by a pre-specified offset if the first oscillator is in transmit mode and the second oscillator is in receive mode.

Another embodiment of the invention is directed to a system for dynamic frequency synthesizer programming. The system can include a first integrated circuit (IC) having a first operating frequency, a second integrated circuit (IC) having a second operating frequency, an application processor (AP) operatively coupled to the first IC and the second IC for managing a first communication of the first IC and a second communication of the second IC, and a base-band processor (BP) operatively coupled to the application processor for adjusting the first operating frequency to mitigate an interference from the second operating frequency of the second IC. The base-band processor can include a tuning control for adjusting the first operating frequency if the first operating frequency and the second operating frequency are within a pre-determined range.

In one arrangement, an inter-processor (IPC) message can be sent from an application processor to a baseband processor identifying a transmit frequency and a receive frequency of the second oscillator. The baseband processor can receive the IPC message, compare the first operating frequency with the transmit frequency and the receive frequency in the IPC message, and adjusting the first operating frequency if the first operating frequency is within a predetermined offset of the transmit frequency or the receive frequency. The method can include determining whether a transmit frequency is an interferer to the first oscillator, or determining if a receive frequency is an interferer to the first oscillator.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 is a block diagram of a system having a controller for managing dual-mode communication in accordance with the embodiments of the invention;

FIG. 2 is an illustration of operating points, wherein a second communication module produces an interference in a first communication module, in accordance with the embodiments of the invention;

FIG. 3 is a method for managing operating points in multiple communication modules in accordance with the embodiments of the invention;

FIG. 4 is a block diagram of a controller using a receive operating point of a second communication module to adjust a transmit operating point of a first communication device in accordance with the embodiments of the invention;

FIG. 5 is a method description for the block diagram of FIG. 4 in accordance with the embodiments of the invention;

FIG. 6 is a block diagram of a controller using a transmit operating point of a second communication module to adjust a transmit operating point of a first communication device in accordance with the embodiments of the invention;

FIG. 7 is a method description for the block diagram of FIG. 6 in accordance with the embodiments of the invention;

FIG. 8 is a method for dynamic frequency programming in accordance with the embodiments of the invention.

FIG. 9 is a more detailed description of the block diagram of FIG. 7 based on the block diagram of FIG. 5. in accordance with the embodiments of the invention; and

FIG. 10 is a more detailed description of the method of FIG. 6 based on the block diagram of FIG. 5. in accordance with the embodiments of the invention.

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

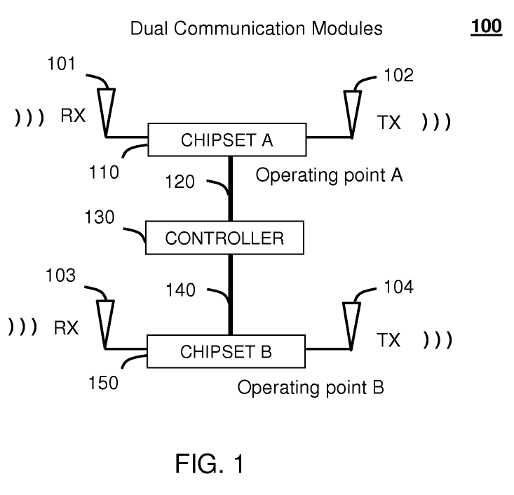

### FIG. 1

Referring to FIG. 1, a block diagram of a system 100 having a controller 130 for managing dual-mode communication is shown. The controller 130 can manage an operating point for a first chipset A (110) and an operating point for a second chipset B (15). A chipset may be a communication module having a self contained transmit modem, receive modem, and processor (not shown) as is known in the art. The chipset may be an integrated circuit (IC) such as an Application Specific Integrated Circuit (ASIC). For example, chipset A 110 (herein, first chipset) may be an iDEN communication module and chipset B 150 (herein, second chipset) may be a CDMA communication module. Other communication modules are herein contemplated, and embodiments of the invention are not limited to those presented.

Briefly, the controller 130 adjusts an operating point 120 of the first chip set 110 to avoid interference with a communication of the second chip set 150. In practice the controller 130 can control the operating point 120 of the first chipset 110 and the operating point 140 of the second chipset 150. However, in certain implementations, one of the chip sets may not expose a control to the operating point. In such regard, the controller 150 passively assess an operating point of the non-controlled chipset and adjusts the operating point of the controllable chipset. For example, in the foregoing, the second chipset 150 can be considered the non-controlled communication module, and the first chipset 110 will be considered the controlled communication module. That is, the controller evaluates an operating point of the second chipset 150, and accordingly adjusts the operating point of the first chipset 110.

The first chip set 110 and the second chip set 150 can operate independently of one another. For purposes of illustration, as shown in FIG. 1, the first chip set 110 may have its own receive element 101 and its own transmit element 102. The second chipset 150 have its own receive element 103 and its own transmit element 104. In practice the receive and transmit elements may include additional processing logic, amplifiers, or circuits, and also share access to a single antennae. The controller 130 can be implemented in software by a processor such as a microprocessor or a digital signal processor (DSP) as is known in the art, but is not limited to such. The controller 130 can also be implemented in hardware such as an Application Specific Integrated Circuit (ASIC) or Field Programmable Gate Array (FPGA) as is known in the art, but is not limited to such.

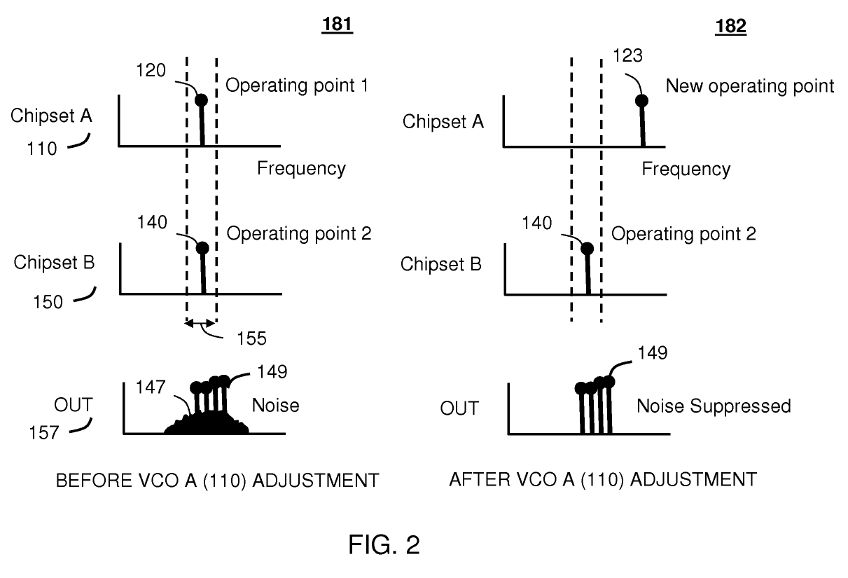

### FIG 2

Referring to FIG. 2, a depiction of the operating points of the first chipset 110 and the second chipset 150 is shown. Specifically, the depiction illustrates how interference can be generated as a result of operating point selection. In particular, illustration 181 shows the introduction of noise 147 as a result of similar operating points, and illustration 182 shows a suppression of the noise 147 as a result of separating the operating points. For example, referring to illustration 181, the first chip set 110 can have a first operating point 120. The operating point may be a carrier frequency of a voltage controlled oscillator (VCO). The second chip set 150 can have a second operating point 140. The first operating point 120 may be within a predetermined range 155 of the second operating point 140. If the operating points are sufficiently close, spurious noise or energy from one chipset can be introduced on another chipset. For example, a high energy transmit pulse of the second chipset 150 may splatter onto a frequency band of the first chipset 110. In this case, an output 149 of the first chipset may contain unwanted noise 147. The output 149 may also be severely distorted as a result of the splatter. In such regard. Referring to illustration 182, the noise can be suppressed by separating the operating points. For example, the first operating point 120 can be moved outside the predetermined range 155 to a new operating point 123, thereby avoiding interference with the second operating point 140. In such regard, noise interference is mitigated on the output 149.

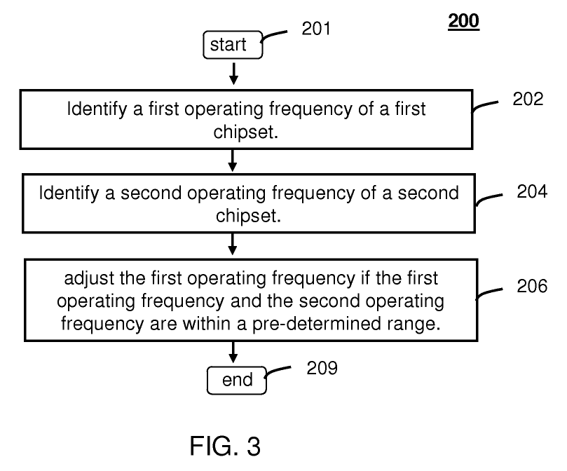

### FIG. 3

Referring to FIG. 3, a method 200 for managing operation of multiple communication modules is shown. The method 200 can be practiced with more or less than the number of steps shown. To describe the method 200, reference will be made to FIG. 1 although it is understood that the method 200 can be implemented in any other manner using other suitable components. In addition, the method 200 can contain a greater or a fewer number of steps than those shown in FIG. 3.

At step 201, the method 200 can start. The method 200 can start in a state wherein a mobile device is operating in two or more communication modes. For example, the mobile device may be using a first communication module in packet mode to receive presence information over a wi-fi connection. The mobile device may also be using a second communication module operating over a circuit switched network for receiving or handling a phone call. The two communication modules allow a user to simultaneously receive packet data while simultaneously processing a voice call. Notably, the method 200 is not limited to dual mode communication, and can include multiple mode communication. That is, multiple communication modules can be included, each having separate operating points for providing one aspect of a seamless communication experience.

At step 202, a first operating frequency of a first chipset can be identified. The first operating frequency may be a carrier frequency of a voltage controlled oscillator (VCO) in the first chipset. For example, the VCO may control transmit and receive modems. Referring back to FIG. 2, the operating point of the first chipset 110 may be a carrier frequency set by the VCO. In one arrangement, the controller 130 (See FIG. 1) can determine the carrier frequency of the first chipset via an interprocessor communication message.

At step 204, a second operating frequency of the second chipset can be identified. The second operating frequency may be a carrier frequency of a voltage controlled oscillator (VCO) in the second chipset. For example, the VCO may control transmit and receive modems. Referring back to FIG. 2, the operating point of the second chipset 150 may be a carrier frequency set by the VCO. Similarly, the controller 130 (See FIG. 1) can determine the carrier frequency of the first chipset via an interprocessor communication message.

At step 206, the first operating frequency can be adjusted if the first the first operating frequency and the second operating frequency are within a predetermined range. For example, referring back to FIG. 2, the controller 130 can move the first operating frequency 120 to the new operating frequency 123, if the first operating frequency 120 is within the predetermined range 155 of the second operating frequency 140. At step 209, the method can end.

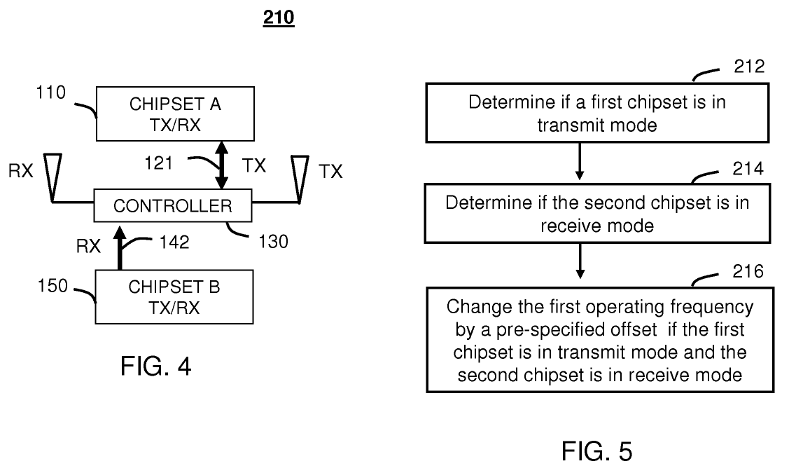

### FIG. 4

Referring to FIG. 4, one exemplary configuration 211 for adjusting the operating points is shown. It should be noted, that the configuration is a function of transmit and receive communication modes. Reference will also be made to FIG. 5 for describing the method steps associated with the configuration 210. Referring to FIG. 5, at step 212, the controller 130 can determine if the first chipset 11 0 is in transmit mode. Briefly, the controller 130 can inquire 121 the first chipset 110 for operating point information. At step 214, the controller can then determine if the second chipset 150 is in receive mode. For example, the controller 130 can inquire 142 the second chipset 150 for operating point information. The controller 130 may perform the steps in a specific order if the interference is greater on the first chipset than the second chipset. Moreover, the controller can identify a priority for the transmit and receive. For example, if transmitting data has a higher priority over receiving data, the operating point associated with the receiving mode can be adjusted. If receiving data has a higher priority over transmitting data, the operating point associated with the transmitting mode can be adjusted. This may avoid any delays or artifacts due to dynamic frequency programming. At step 216, the controller 130 can change the first operating frequency by a pre-specified offset if the first chipset 110 is in transmit mode and the second chipset 150 is in receive mode. For example, referring back to FIG. 2, it was illustrated that separating the operating points mitigates noise conditions.

### FIG. 5

In practice, referring to FIG. 5, the controller 130 can identify a receive operating frequency 142 of the second chip set 150, and adjust a transmit operating frequency 121 of the first chipset 110 based on current operating points of the first chipset 110. For example, the first chipset may be an iDEN communication module, and the second chipset may be a CDMA communication module. As previously illustrated in FIG. 2, an interference can be introduced on the first chipset 110 if the second chipset 150 is receiving while the first chipset is transmitting. The controller 130 can keep track of the transmit and receive times for both communication modules, and adjust the operating points accordingly. The transmit and receive times may not always coincide, therefore, the controller 130 may need only to adjust the operating points during coincided transmit and receive events. At other times, when the communication modes are not coincident, the controller 130 can keep the operating points at their default values.

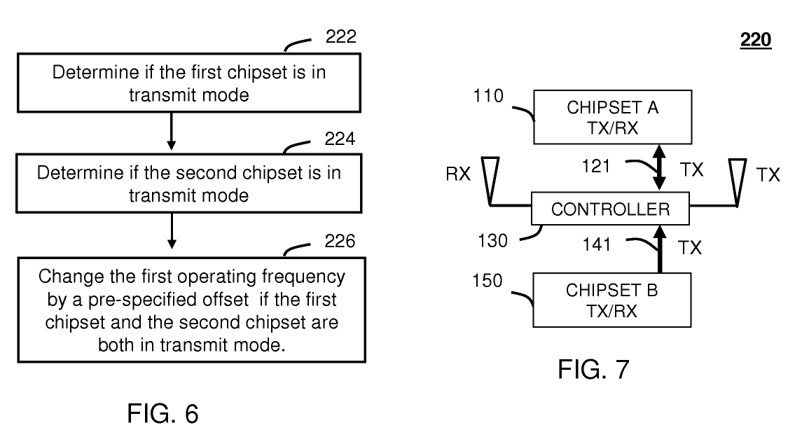

### FIG. 6

Referring to FIG. 6, another exemplary configuration 211 for adjusting the operating points is shown. It should be noted, that the configuration is a function of only transmit communication mode. Reference will also be made to FIG. 7 for describing the method steps associated with the configuration 211. Referring to FIG. 6, at step 222, the controller 130 can determine if the first chipset 110 is in transmit mode. The first chipset may be transmitting using a circuit switched connection or a packet data connection. At step 224, the controller 130 can determine if the second chipset 150 is in transmit mode. Notably, the first chipset 110 and the second chipset 150 can operate independently of one another for providing seamless mobility. At step 226, the controller 130 can change the first operating frequency by a pre-specified offset if the first chipset 110 and the second chipset 150 are both in transmit mode

### FIG. 7

In practice, referring to FIG. 7, the controller 130 can determine a transmit operating frequency 141 of the second chip set 150, and adjust the transmit operating frequency 121 of the first chipset 110 based on a current operating point of the first chipset 110. Notably, an interference can be introduced on the first chipset if the second chipset is transmitting while the first chipset is transmitting. Generally, a transmit operation produces a communication signal with much higher energy that a received signal, since the transmitted signal needs to reach a base station that may be far away. A high energy transmit on the second chipset 150 can severely degrade a simultaneous transmit on the first chip set 110. The controller 130 can keep track of the transmit times for both communication modules, and adjust the operating points accordingly. In particular, the controller 130 can monitor the operating point of the second chipset 150 and adjust the operating point of the first chipset 110 to avoid interference. This involves moving the first operating frequency away from the second operating frequency as shown in FIG. 2.

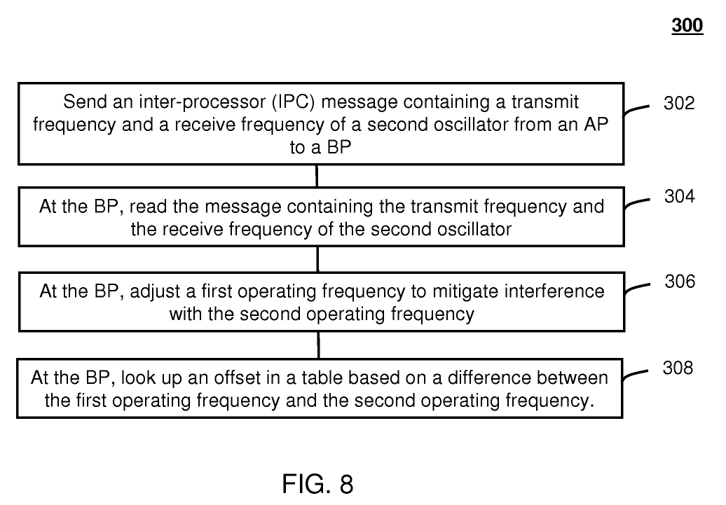

### FIG. 8/9

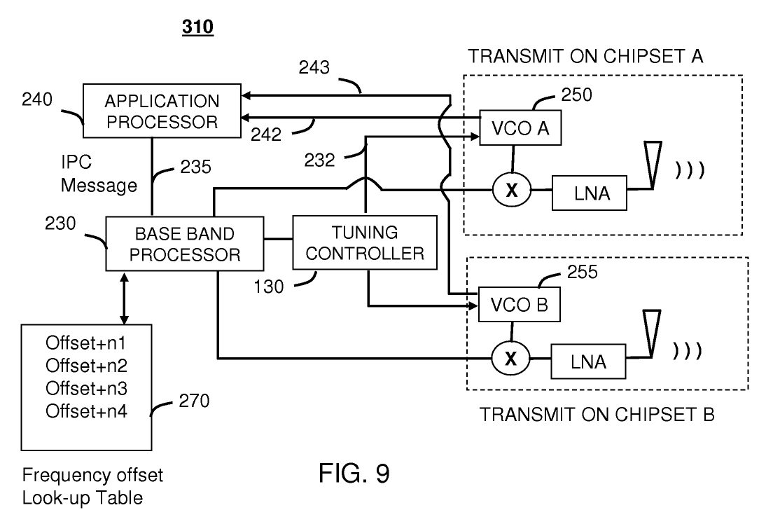

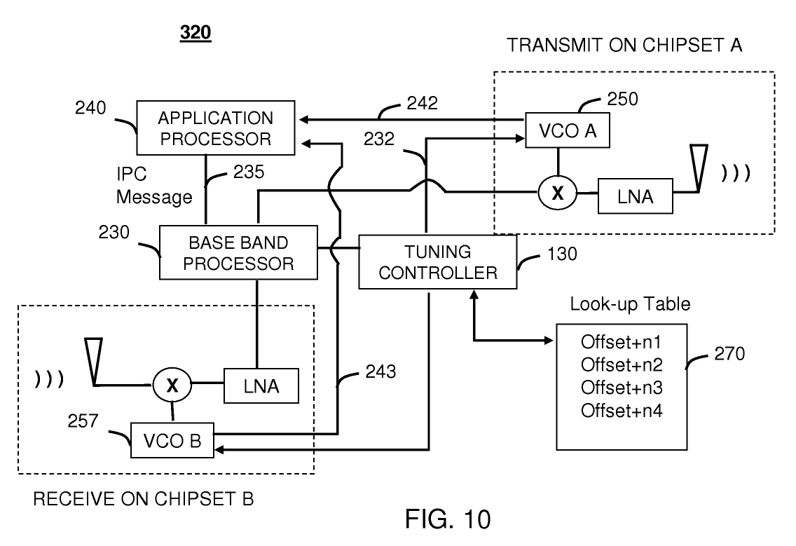

Referring to FIG. 8, a method 300 for dynamic frequency synthesizer programming is shown. The method 300 can be practiced with more or less than the number of steps shown. To describe the method 300, reference will be made to FIG. 9 and 10, although it is understood that the method 300 can be implemented in any other manner using other suitable components. In addition, the method 300 can contain a greater or a fewer number of steps than those shown in FIG. 8.

At step 302, an inter-processor (IPC) message containing a transmit frequency and a receive frequency of a second oscillator can be sent from an Application Processor (AP) to a Base Processor (BP). Referring to FIG. 9, a schematic 310 of the block diagram 220 of FIG. 7 is shown. The schematic 310 is a more detailed description of the block diagram 220 of FIG. 7. In particular, the schematic 31 0 identifies components associated with a transmit operation on the first chipset 11 0 and a transmit operation on the second chipset 150. Receive operations for the first chipset 110 or the second chipset 150 are not shown in discussion of the schematic 310. Briefly, the tuning controller 130 adjusts a transmit frequency on the first chipset 110 if a transmit frequency on the second chipset 150 causes interference, or is within a predetermined offset.

Notably, the AP 240 can oversee operational aspects of the first chipset 110 and the second chip 150. The AP can also provide top layer applications that are not directly visible through the BP 230. The BP 230 performs the physical layer signaling and data layer signaling, and may not have access to the operating points. In operation, the AP can identify the operating frequencies of the first chipset 110 and the operating frequencies of second chipset 150. In particular, the AP 240 can receive a message 243 from chipset 150 identifying its transmit operating frequency 255. The AP 240 can also receive a message 242 from chipset 110 identifying its transmit operating frequency 250. The AP 240 can send an interprocessor message 235 to the BP identifying the first transmit frequency 250 and the second transmit frequency 255.

Returning back to FIG. 8, at step 304, the BP can read the message 235 containing the transmit frequency and the receive frequency of the second oscillator. For example, referring to FIG. 9, the BP 230 can receive the IPC message 235 to determine the first operating frequency 250 and the second operating frequency 255. If the IPC message 235 is not received, the BP 230 can set a default operating frequency for the first chipset 110. As a specific example, the default value of 26 can be set for the first operating frequency 250 and the second operating frequency 255. The operating frequency 250 can be adjusted based on a clock cycles or fractional values.

At step 306, the BP can adjust the first operating frequency to mitigate interference with the second operating frequency. Referring to FIG. 9, the BP 230 can determine a difference between the first operating frequency 250 and the second operating frequency 255. The first operating frequency can be calculated as follows:

iDEN VSO frequency=((iDEN TX frequency)/NUD)*3

where iDEN is the first chipset 110, NUD is a near-unity device value, and the factor 3 is chosen for scaling. In practice, the BP 230 computes the difference for each transmit cycle. The BP can then relay the difference to the tuning controller 130 to adjust the first transmit frequency 250 to a location that mitigates interference with the second transmit frequency.

If the first operating frequency is within a specified offset of the second operating frequency, the first chipset NUD value can be modified to a different setting. Briefly, the NUD is available through the tuning controller 130 since it sets the operating frequency. Notably, the BP 230 determines the amount of adjustment to the first operating frequency, and the tuning controller 130 carries out the task of setting the operating frequency. The following pseudo code reveals the control logic when VCOB of transmitter (TX B 255) of chipset B (150) is the interferer to the VCOA of transmitter (TX A 250) of chipset A (110):

```
If(abs(VCO_{B} − VCO_{A})) < offset 1)
    Change NUD to NUD_TX;
Else
    Do not change NUD
```

Notably, the pseudo code is presented in accordance with the configuration 210 of FIG. 4, and the method steps of FIG. 5. Referring back to FIG. 8, at step 308, the BP can look up an offset in a table based on a difference between the first operating frequency and the second operating frequency. A range of the offset can be between 0.6 and 1.2. For example, the offsets (in MHz) between the first chipset 110 operating frequencies and the second chipset 120 operating frequencies specified in the equation above can be stored in a code plug. The code plug is a non-volatile memory unit that allows for the storing of data.

Referring to FIG. 9, the offsets can be saved in a look-up table 270, thereby allowing frequency adjustments to be performed in a look-up manner. That is, predetermined offsets can be retrieved from the look-table 270 stored in a code plug. The BP 230, can either compare the operating frequencies, or look up an associated offset for the operating frequencies in the look-up table. That is, the determination of the adjustment to the first operating frequency can be determined by table look-up. The tuning controller 130 can then adjust the first operating frequency 250 in accordance with the look-up value. For example, the tuning controller can then change the first operating frequency 250 via signal line 232.

### FIG. 10

Referring to FIG. 10, a schematic 320 of the block diagram 210 of FIG. 4 is shown. The schematic 320 is a more detailed description of the block diagram 210 of FIG. 4. In particular, the schematic 320 identifies components associated with a transmit operation on the first chipset 110 and a receive operation on the second chipset 150. Transmit operations for the second chipset 150 and receive operations for the first chipset 110 are not shown in discussion of the schematic 320. Briefly, the tuning controller 130 adjusts a transmit frequency 250 on the first chipset 110 if a receive frequency 257 on the second chipset 150 causes interference, or is within a predetermined offset.

Notably, the AP 240 can oversee operational aspects of the first chipset 110 and the second chip 150. In particular, the AP 240 can receive a message 243 from second chipset 150 identifying its receive operating frequency 257. The AP 240 can also receive a message 242 from first chipset 110 identifying its transmit operating frequency 250. The AP 240 can send an interprocessor message 235 to the BP identifying the first transmit frequency 250 and the second receive frequency 257.

The BP 230 can determine a difference between the first operating frequency 250 and the second operating frequency 257. In practice, the BP 230 computes the difference for each receive cycle. The BP 230 can then relay the difference to the tuning controller 130 to adjust the first transmit frequency 250 to a location that mitigates interference with the second receive frequency 257. If the first transmit frequency 250 is within a specified offset 155 (See FIG. 2) of the second receive frequency, the first chipset NUD value can be modified to a different setting. The following pseudo code reveals the control logic when VCOB of receiver (RX B 257) of chipset B (150) is the interferer to the VCOA of transmitter (TX A 250) of chipset A (110):

```
If(abs(VCO_{B} − VCO_{A})) < offset 2)
    Change NUD to NUD_RX;
Else
    Do not change NUD
```

Similarly, the offsets can be saved in a look-up table 270 of a code plug. Having the look-up tables in the code plug facilitates tuning operations, such as tweaking the parameters during code development.

In summary, embodiments of the invention provide for adjusting of a first operating frequency in a first chipset in view of a second operating frequency, or an adjusting in view of an interference due to a communication of a second chipset. This allows the first chipset to compensate for fixed known interference sources, or changing interference sources.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention is not so limited. Numerous modifications, changes, variations, substitutions and equivalents will occur to those skilled in the art without departing from the spirit and scope of the present embodiments of the invention as defined by the appended claims.

1. A method for dynamic frequency synthesizer programming, comprising:
identifying a first operating frequency of a first oscillator;
identifying a second operating frequency of a second oscillator;
adjusting the first operating frequency if the first operating frequency and the second operating frequency are within a pre-determined range.

2. The method of claim 1, further comprising:
determining if the first oscillator is in transmit mode,
determining if the second oscillator is in transmit mode,
if the first oscillator and the second oscillator are both in transmit mode, changing the first operating frequency by a pre-specified offset.

3. The method of claim 1, further comprising:
determining if the first oscillator is in transmit mode,
determining if the second oscillator is in receive mode,
if the first oscillator is in transmit mode and the second oscillator is in receive mode, changing the first operating frequency by a pre-specified offset.

4. The method of claim 1, wherein the first oscillator and the second oscillator operate independently of one another.

5. The method of claim 1, further comprising:
sending an inter-processor (IPC) message containing a transmit frequency and a receive frequency of the second oscillator;
receiving the IPC message;
comparing the first operating frequency with the transmit frequency and the receive frequency in the IPC message; and
adjusting the first operating frequency if first operating frequency is within a predetermined offset of the transmit frequency or the receive frequency.

6. The method of claim 5, further comprising determining if the transmit frequency is an interferer to the first oscillator.

7. The method of claim 5, further comprising determining if the receive frequency is an interferer to the first oscillator.

8. The method of claim 5, wherein the adjusting includes changing a near unity device to a look-up table value based on the comparing, wherein the near unity device establishes the first operating frequency.

9. A system for dynamic frequency synthesizer programming, comprising:
a first integrated circuit (IC) having a first operating frequency;
a second integrated circuit (IC) having a second operating frequency;
an application processor (AP) operatively coupled to the first IC and the second IC for managing a first communication of the first IC and a second communication of the second IC; and
a base-band processor (BP) operatively coupled to the application processor for adjusting the first operating frequency to mitigate an interference from the second operating frequency of the second IC.

10. The system of claim 9, wherein the base-band processor includes a tuning control for adjusting the first operating frequency if the first operating frequency and the second operating frequency are within a pre-determined range.

11. The system of claim 9, wherein the AP sends an inter-processor (IPC) message to the BP identifying a transmit operating frequency and a receive operating frequency of the second IC.

12. The system of claim 11, wherein the BP receives the inter-processor (IPC) message and adjusts the first operating frequency of the first IC if transmit operating frequency or the receive operating frequency interfere with the first operating frequency.

13. A system for dynamic frequency synthesizer programming, comparing:
a first integrated circuit (IC) having a first receive modem and a first transmit modem;
a second integrated circuit (IC) having a second receive modem and a second transmit modem; and
a tuning controller communicatively coupled to the first IC and the second IC, for identifying a first operating frequency of a first oscillator in the first IC and identifying a second operating frequency of a second oscillator in the second IC.

14. The system of claim 13, wherein the tuning controller determines if the first oscillator is in transmit mode, determines if the second oscillator is in transmit mode, and changes the first operating frequency by a pre-specified offset if the first oscillator and the second oscillator are both in transmit mode.

15. The system of claim 13, wherein the tuning controller determines if the first oscillator is in transmit mode, determines if the second oscillator is in receive mode, and changes the first operating frequency by a pre-specified offset if the first oscillator is in transmit mode and the second oscillator is in receive mode.

16. The system of claim 13, wherein the pre-specified offset is stored in a code-plug table.

17. The system of claim 13, wherein the tuning controller is a Digital Signal Processor.

18. The system of claim 13, wherein the controller:
receives an Inter-processor Communication (IPC) from the first IC identifying the first operating frequency;
receives an Inter-processor Communication (IPC) from the second IC identifying the second operating frequency;
compares the first operating frequency to the second operating frequency; and
changes the first operating frequency by sending an Inter-processor Communication (IPC) to the first IC if the first operating frequency interferes with the second operating frequency.

19. The system of claim 13, wherein the first IC provides communication using integrated Dispatch Enhanced Network (iDEN), and the second IC provides communication using Code Division Multiple Access (CDMA).

20. The system of claim 13, wherein the first oscillator or the second oscillator is a frequency synthesizer.
